(19) United States
(12) Patent Application Publication
(10) Pub. No.: US 2019/0022811 A1
(43) Pub. Date: Jan. 24, 2019

(54) MACHINING APPARATUS

(71) Applicant: HOMAG BOHRSYSTEME GMBH, Herzebrock-Clarholz (DE)

(72) Inventor: Boris ROETTGEN, Langenberg (DE)

(21) Appl. No.: 16/063,995

(22) PCT Filed: Dec. 20, 2016
(86) PCT No.: PCT/EP2016/081943

§ 371 Date: Jun. 19, 2018

(30) Foreign Application Priority Data
Dec. 21, 2015 (DE) 10 2015 226 299.5

(51) Int. Cl. B23Q 11/08; B23Q 1/00

(52) U.S. Cl. CPC B23Q 11/0891; B23Q 17/2208; B23Q 1/0045

(57) ABSTRACT

The present invention relates to a machining apparatus for machining workpieces. These workpieces can be, merely as an example, workpieces of wood, wood materials, synthetics or the like. The machining apparatus comprises a machine bed (10) and a machining unit (20) movable along the machine bed (10), in the housing (21) of which a machining aggregate (25) is provided, at least one sensor (30a, 30b, 30c, 30d; 40) mounted on the housing (21) of the machining unit, which is provided for monitoring a travel movement of the machining unit (20), an operating element (50a, 50b, 50c) being provided on the housing (21) of the movable machining unit to input an operating command for the machining unit (20), in particular a command to start or stop.

### TECHNICAL FIELD

The present invention relates to a machining apparatus for machining workpieces. These workpieces can be, merely as an example, workpieces of wood, wood materials, synthetics or the like.

### PRIOR ART

In the field of machining apparatus for the furniture and components industry, CNC machines are known which work with respect to different safety concepts. In this regard, conventional solutions are step mats, light barriers as well as protective fences. Generally, the tendency is towards those safety concepts allowing a user to come relatively close to a movable machining unit and, in so doing, to undertake operations while the machining unit is machining a workpiece in another area of the machining apparatus.

DE 20 2009 007 035 U1 discloses in this regard a machining apparatus with at least one movable machining unit comprising a first sensor configured to detect objects and persons entering a safety area defined within an area of the machining unit. The machining unit can travel here between two dynamic areas and each workpiece can be machined in one of these two dynamic areas by means of the movable machining unit while a loading and unloading of workpieces takes place in the second dynamic area. Furthermore, a second sensor is provided on the machining apparatus that is configured to detect objects and persons present in the second dynamic area prior to the machining unit travelling to the second dynamic area.

A further known safety concept is stated in EP 1 918 629 A1 which shows a machining apparatus comprising a plurality of machine units including at least one machining unit and at least one workpiece clamping unit, at least one contact sensor and at least one contactlessly operating sensor. Owing to a signal of the contactlessly operating sensor, the machining apparatus continues to work at a reduced movement speed and is completely stopped when the at least one contact sensor arranged on the at least one machine unit detects a contact with a person or another object.

Furthermore, DE 10 2012 217 762 A1 is known which shows a machining apparatus with a machine bed as well as a machining unit arranged to be movable along the machine bed. A contact sensor is provided on the machining unit as well as a contactlessly operating sensor, the contactlessly operating sensor being provided on the contact sensor.

### SUBJECT MATTER OF THE INVENTION

An objective of the present invention is to provide a machining apparatus with a new operating and/or safety concept in which activities of a user while the apparatus is possibly in operation are enabled in a simple and safe manner.

The subject matter of claim 1 provides a respective machining apparatus which is provided in particular for shuttle machining. Further preferred embodiments are provided in the dependent claims, with individual features of the dependent claims being able to be combined with other features, for example features of independent claim 1.

The core idea of the present invention is to provide an operating element on a movable machining unit of a machining apparatus, with which an operating command for the machining unit can be input. In addition to these features, further individual features are stated in independent claim 1, which, however, only supplement the core idea.

With this apparatus according to the invention, a convenient operating possibility is ensured while providing a safety concept at the same time. Owing to the intuitive operating possibility, the amount of training for users is reduced.

According to claim 1, a machining apparatus is provided comprising the following features: a machine bed and a machining unit movable along the machine bed, with a machining aggregate being provided in the housing thereof, at least one sensor mounted on the housing of the machining unit provided for monitoring a travel movement of the machining unit, with a first operating element being provided on the housing of the movable machining unit to input an operating command for the machining unit, in particular a command to start or stop.

Said sensor can be a contact sensor or a contactlessly operating sensor with which a person or an object coming into contact with the machining unit or entering a safety area around the machining unit can be recognized. The travel movement of the machining unit is thus monitored.

A carrier is preferably provided on the machine bed on which an actuating element is mounted for inputting an operating command for the machining unit. By providing the actuating element on the machine bed, the operating convenience can be increased in certain situations, in particular when a user is already in close vicinity to the machine bed.

An embodiment is configured such that two carriers each with one actuating element are mounted on the machine bed, with one workpiece-retaining unit or a plurality thereof being provided between the carriers. Thus, the actuating elements on outer positions are arranged in relation to the machine bed, so that these are accessible when the machining unit is located on the respective other side of the machine bed.

Such an arrangement is particularly advantageous when the apparatus is working in shuttle mode where a workpiece is taken from or laid into an area while another workpiece is being machined in another area.

It is provided in one embodiment that the operating element is an operating button or a touch-sensitive element. Thus, the user can detect via touch that a correct actuation was undertaken.

Furthermore, it is preferred that the sensor is a contact sensor, in particular a bumper, provided on a lateral side of the housing of the machining unit. Thus, a contact of the housing of the machining unit is detected with certainty. However, it is possible that a user is relatively near to the machining unit.

In a further embodiment, a further contactlessly operating sensor is mounted on the machining unit, in particular on a lower section thereof, in particular a capacitive sensor, a laser sensor, an infrared sensor, an ultrasonic sensor, a laser triangulation sensor or a radar sensor. In this manner, a safety area around the machining unit can be defined.

The machining apparatus preferably comprises a control apparatus configured to temporarily stop a movement of the machining unit, based on an operating command, and to continue the movement of the machining unit when the operating element is actuated again. The operating command can be actuated here by either the operating element or the further operating element. Thus, an interaction of the user with the machining unit is possible.

A further embodiment provides that the machining apparatus comprises a control apparatus configured to stop a movement of the machining unit, based on a detection signal of the sensor and/or the further contactlessly operating sensor, and to start a movement of the machining unit, based on an operating command of the operating element. In this manner, an advantageous combination of a safety concept and a convenient operation is being provided.

It can furthermore be provided that the operating element is mounted on a side of the housing facing away from the machine bed. An arrangement in an upper section of the housing is preferred. Thus, the operating element is easily accessible and clearly visible.

Additionally, several operating elements can be provided on the housing of the movable machining unit, in particular several operating buttons or touch-sensitive elements. Different functions can be attributed to the plurality of operating elements, which are possibly intuitively perceivable owing to a respective arrangement of the operating elements.

For example, a different operating command is attributed to each operating element, with preferably one of the operating elements being able to initiate an operating command for the machining aggregate (for example a command for a movement of the machining aggregate or a tool thereof in vertical direction) and preferably another operating element being able to initiate an operating command for a movement of the machining unit. Owing to the attribution of specific operating commands, it is not necessary to select a command from a menu. On the contrary, a simple actuation of a specific operating element is sufficient.

Furthermore, based on a mode of the machining apparatus, one operating command each can be attributed to the operating elements. For example, the machining apparatus can be in a sleep mode in which workpiece machining does not take place, or it can be in a machining mode in which workpiece machining takes place. By attributing an operating command depending on the respective mode, a plurality of operating commands can be attributed to one operating element, however the user is able to trigger only one of these operating commands, namely that which is allowed by the operating mode of the machining apparatus.

According to a further variant of the present invention, one or more further operating elements can be mounted on the housing on an opposite side of the operating element previously described. This further operating element(s) can have the same function as the previously described operating element(s). Thus, the apparatus can be operated on both sides according to this variant.

Additionally, it is possible according to this variant to also provide the actuating element(s) on the respective opposite side of the respective beam. This configuration as well enables operation of the apparatus on both sides.

### SHORT DESCRIPTION OF THE DRAWINGS

FIG. 1 shows a machining apparatus according to a preferred embodiment of the present invention;

FIG. 2 shows a further view of the machining apparatus shown in FIG. 1;

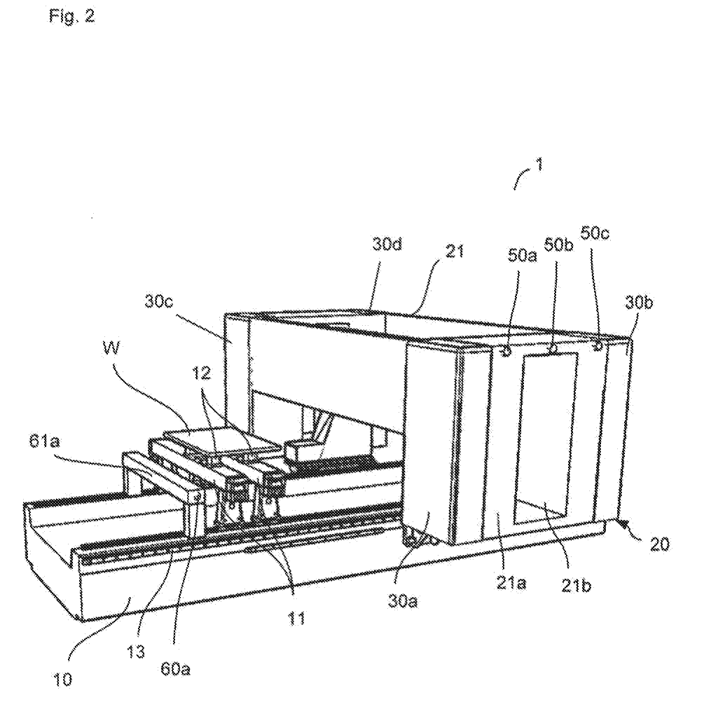

FIG. 3 is a top view of the machining apparatus shown in FIG. 1.

### DETAILED DESCRIPTION OF THE PREFERRED EMBODIMENT

A preferred embodiment of the present invention will be described in detail below on the basis of the attached figures. Further modifications of specific features mentioned in this regard can each be individually combined to form new embodiments.

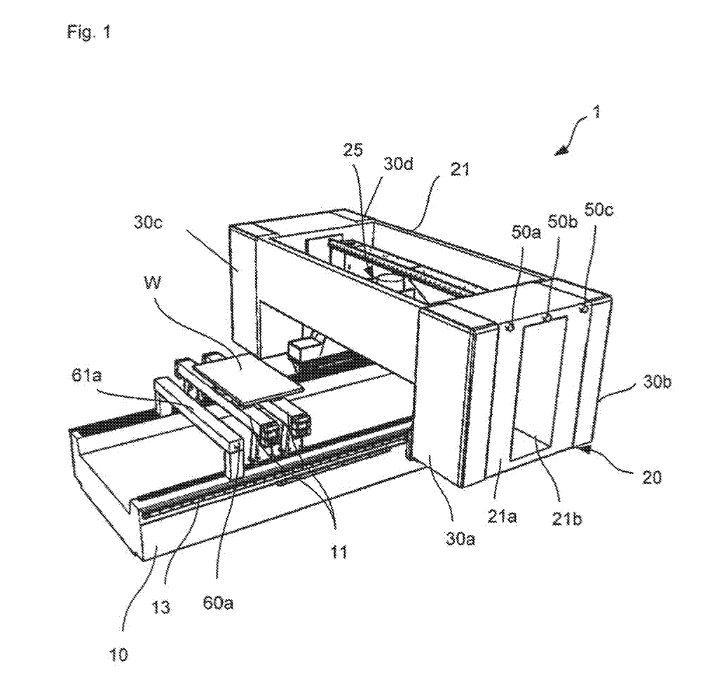

The machining apparatus 1 shown in FIG. 1 comprises a machine bed 10 resting on a base (floor of a hall). In the embodiment shown, the machine bed 10 is U-shaped in cross-section, with a plurality of work carriers (workpiece-retaining units) 11 being mounted on the upper edges of the machine bed 10. The work carriers 11 can be moved in longitudinal direction along the machine bed 10. Furthermore, clamping elements 12 (here: vacuum clamps) with which a workpiece W can be held are provided on each work carrier 11.

It is apparent that in an alternative embodiment the machine bed 10 can also be configured with a flat workpiece support surface, for example in combination with a vacuum mat. Furthermore, it is apparent that clamping apparatus or other retaining mechanisms can also be used for workpieces W on one work carrier or plural work carriers 11 instead of the vacuum clamp 12.

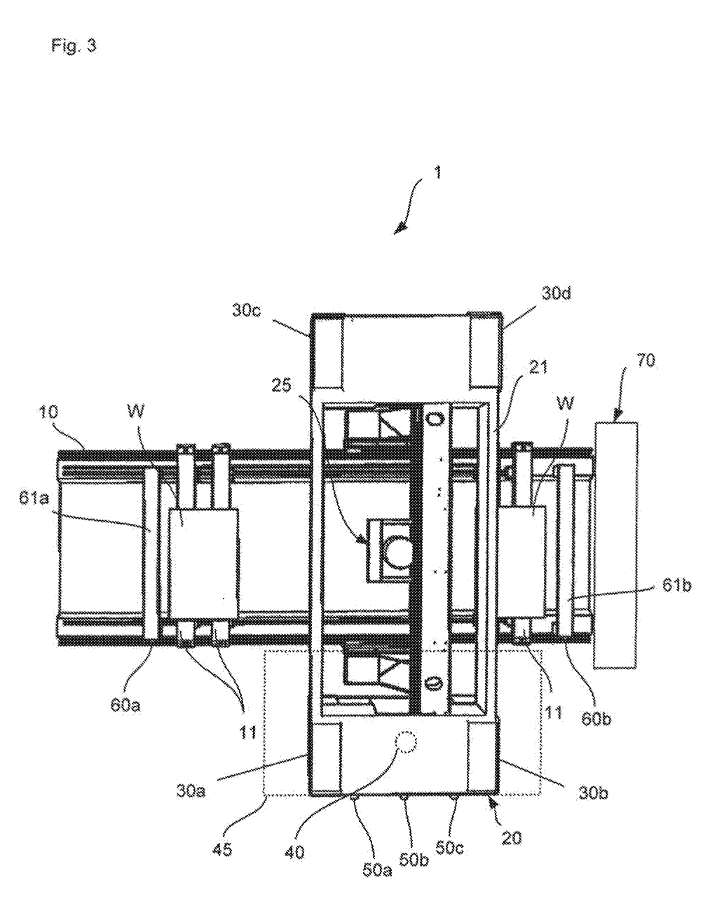

On one side of the machine bed (to the right side in the top view of FIG. 3), a tool changing station 70 is provided. This tool changing station 70, which is only schematically shown, is provided for accommodating tools which can be substituted into the machining aggregate 25. This machining unit 20 can be moved into this area of the machine bed to perform a tool change.

The machining apparatus 1 is preferably provided for shuttle machining. Thus, a first machining area is defined in a section of the machine bed 10 (in the left area of the machine bed 10 in FIG. 3) and another machining area is defined in another section of the machine bed (in the right area of the machine bed 10 in FIG. 3).

In order to ensure that the machining unit 20 can travel, guide rails 13, along which a machining unit 20 can be moved, extend to outer sides of the machine bed 10 according to the present embodiment. The machining unit 20 comprises a housing 21 within which a machining aggregate 25 is located. The housing 21 serves to shield a dynamic machining area and to protect a user. The machining area is designated in this connection as “dynamic” since it changes owing to a movement of the machining unit 20 along the machine bed 10.

The machining aggregate 25 can be, for example, a 4-axis, 5-axis or 6-axis machining aggregate. It is in particular a milling and/or drilling aggregate.

On a front face 21a of the housing 21, a window 21b is provided such that a machining process by the machining aggregate 25 can be monitored by a user.

The housing 21 protrudes in sections over the outer surface of the machine bed 10. In this area of the housing 21, contact sensors (so-called “bumpers”) 30a, 30b are mounted on side faces of the housing 21. The contact sensors 30a, 30b extend from a bottom face to an upper face of the housing 21 and are thus configured as a surface.

At a further area of the housing 21, opposite the area of the housing 21 on which the contact sensors 30a, 30b are mounted, further contact sensors 30c, 30d are mounted in a similar manner as the contact sensors 30a, 30b. Also in the area of the further contact sensors 30c, 30d, the housing 21 protrudes beyond the machine bed 10.

If, for example, one of the contact sensors 30a, 30b (or 30c, 30d) comes with a user or an object situated in the travel path of the machining unit 20, the machining unit 20 is stopped.

Three operating elements are located on the front face 21a of the housing 21 in the upper section thereof, namely a first operating element 50a, a second element 50b as well as a third element 50c which are mounted in this order from left to right on the front face 21a of the housing 21. In the present embodiment, the operating elements are formed as push buttons. In other embodiments, these can also be touch-sensitive operating elements with a touch-sensitive surface.

Beams 61a, 61b, each with an operating element 60a, 60b, are furthermore mounted on side positions of the machine bed 10. The beams 61a, 61b extend over the machine bed 10 in a similar manner as does the work carriers 11. In the present embodiment, the work carriers 11 are arranged between the two beams 61a, 61b.

A corresponding operating element 60 is mounted at an end section of the respective beam 61a, 61b. The actuating elements 61a, 61b are preferably formed as push buttons, similar to the operating elements 50a-50c, however, they can also comprise a different configuration (for example, touch-sensitive actuating elements).

Since the beams 61a, 61b and thus the operating elements 60a, 60b thereof are located at side positions of the machine bed 10, it may be that a corresponding actuating element 60a, 60b is not accessible to the user owing to the positioning of the machining unit 20. In this case, however, the user is able to access the operating elements 50a-50c.

The operating elements/actuating elements 50a-50c, 60a-60b trigger specific control commands when actuated, which depend at least in part also on the operating state of the machining apparatus 1 in the embodiment described below.

If, for example, the machining apparatus 1 is in a “sleep mode” where the machining aggregate 25 does not perform machining processes, a user can move the machining unit 20 in a right area of the machine bed 10 by actuating the third operating element 50c when the machining unit 20 is arranged in a left area of the machine bed 10. This operating possibility is intuitively recognizable owing to the arrangement of the third operating element 50c in a right area of the front face 21a of the housing.

If the machining unit 20 is in a “sleep mode” in the right area of the machine bed 10, a user can move the machining unit 20 in a left area of the machine bed 10 by actuating the first operating element 50a.

In the present embodiment, the second operating element 50b arranged between the first and the third operating elements serves to have the machining aggregate 25 travel in vertical direction upwards. Thus, the user can better examine the previously machined section of a workpiece.

If the machining apparatus 1 is in “machining mode” in which a workpiece W is machined by the machining aggregate 25, a different control command can be effected by actuating one of the operating elements 50a-50c. It is in particular possible to trigger a temporary interruption of the machining process (pause) by actuating the first or third operating element 50a, 50c. Such a temporary interruption of the machining process, however, does not lead to termination of the program. If the machining is to be continued, the machining can be continued by re-actuating one of the operating elements 50a, 50c.

The beams 61a, 61b arranged at lateral positions of the machine bed 10, each with an actuating element 60a, 60b, are moreover provided on the machine bed 10. Similar functions as with the first and third operating elements 50a, 50c are attributed to the actuating elements 60a, 60b. Thus, a user can possibly actuate also one of these actuating elements 60a, 60b to trigger one of the control commands already described, provided that the actuating elements 60a, 60b are accessible. In this manner, the operating convenience can be increased in specific situations.

In FIG. 3, a further sensor 40, designed as a contactlessly operating sensor, is schematically shown. In the present case, this is a laser sensor.

The contactlessly operating sensor 40 is mounted on a lower side of the housing 21 and can monitor a monitoring area 45. If, for example, a user B, as depicted in FIG. 3, places a workpiece W on the work carrier 11 in one area while in another area a machining of another workpiece W is carried out by the machining unit 20, the contactlessly operating sensor 40 can determine whether the machining unit 20 comes too close to the user. This could be the case when the machining unit 20 is to be moved in the direction of the tool changing station 70 in order to carry out a change of tools. If in so doing the contactlessly operating sensor 20 recognizes the user B, the movement of the machining unit 20 is stopped. By actuating one of the operating elements, in particular the third operating element 50c, the process can be resumed by the user.

The contactlessly operating sensor 40 can configure a two-step safety concept also together with the contact sensors 30a, 30b. If, for example, a user enters the monitoring area 45, the movement of the machining unit 20 slows down. If one of the contact sensors comes into contact with the user, the machining process and the movement of the machining unit 20 are completely stopped. To continue the machining process, the user can actuate one of the operating elements/actuating elements 50a, 50c, 60a, 60b.

Even if contact sensors 30a-30d are mounted on two opposite sides of the housing 21 in the embodiment described above, it is possible, according to a modification of the described embodiment, to provide only the contact sensors 30a, 30b or, alternatively, the contact sensors 30c, 30d.

According to a further variant of the present invention, the operating elements 50a-50c can be mounted on the housing 21 in that area in which the contact sensors 30a, 30b are provided, as described above, and further operating elements, not shown here, can be additionally mounted on the opposite side of the housing 21 (in the area of the contact sensors 30c, 30d). These further operating elements can be similarly designed and/or have the same function as the operating elements 50a-50c. Thus, the apparatus according to this variant can be used from both sides. In other words, a user can approach the apparatus from both sides.

Additionally, it is possible, according to this variant, to provide also the actuating elements 60a, 60b on the respective opposite side of the respective beam 61a, 61b. This configuration also allows the operability of the apparatus from both sides.

1. A machining apparatus for machining workpieces, in particular in shuttle mode, comprising:
a machine bed and a machining unit movable along the machine bed, in a housing of which a machining aggregate is provided,
at least one sensor mounted on the housing of the machining unit, which is provided for monitoring a travel movement of the machining unit,
characterized in that an operating element is provided on the housing of the movable machining unit to input an operating command, in particular a command to start or stop, for the machining unit.

2. The machining apparatus according to claim 1, characterized in that a carrier is provided on the machine bed, in particular a beam on which an actuating element is mounted on input an operating command for the machining unit.

3. The machining apparatus according to claim 1, characterized in that two carriers each with an actuating element are mounted on the machine bed, with one or plural workpiece-retaining units being provided between these carriers.

4. The machining apparatus according to claim 1, characterized in that the operating element is an operating button or a touch-sensitive element.

5. The machining apparatus according to claim 1, characterized in that the sensor is a contact sensor, in particular a bumper, which is provided on a lateral side of the housing of the machining unit.

6. The machining apparatus according to claim 1, characterized in that a further contactlessly operating sensor is mounted on the machining unit, in particular at a lower section thereof, in particular a capacitive sensor, a laser sensor, an infrared sensor, an ultrasonic sensor, a laser triangulation sensor or a radar sensor.

7. The machining apparatus according to claim 1, characterized in that the machining apparatus comprises a control apparatus configured to temporarily stop a movement of the machining unit based on an operating command, and to continue the movement of the machining unit when the operating element is actuated again.

8. The machining apparatus according to claim 1, characterized in that the machining apparatus comprises a control apparatus configured to stop a movement of the machining unit based on a detection signal of the sensor and/or the further contactlessly operating sensor, and to start a movement of the machining unit based on an operating command of the or, optionally, of an actuating element.

9. The machining apparatus according to claim 1, characterized in that the operating element is mounted on a side of the housing facing away from the machine bed.

10. The machining apparatus according to claim 1, characterized in that plural operating elements are provided on the housing of the movable machining unit, in particular plural operating buttons or touch-sensitive elements.

11. The machining apparatus according to claim 10, characterized in that the operating elements are provided on an upper section of the housing.

12. The machining apparatus according to claim 10, characterized in that one other operating command each is attributed to the operating elements, one of the operating elements preferably being able to initiate an operating command for the machining aggregate and another operating element preferably being able to initiate an operating command for a movement of the machining unit.

13. The machining apparatus according to claim 1, characterized in that one operating command each is attributed to the operating element or, optionally, to the plurality of operating elements based on an operating mode of the machining apparatus.

14. A use of a machining apparatus according to claim 1 for machining a workpiece, the machining apparatus working in particular in shuttle mode.
